(19) United States
(12) Patent Application Publication
(10) Pub. No.: US 2023/0318147 A1
(43) Pub. Date: Oct. 5, 2023

(54) BUSBAR WITH NUT PLATE

(71) Applicant: Rivian IP Holdings, LLC, Irvine, CA (US)

(72) Inventors: Tyler Jacobs, Redondo Beach, CA (US); Brian Pham, Westminster, CA (US)

(73) Assignee: Rivian IP Holdings, LLC, Irvine, CA (US)

(21) Appl. No.: 17/712,472

(22) Filed: Apr. 4, 2022

(51) Int. Cl. H01M 50/503; H01M 50/507

(52) U.S. Cl. CPC H01M 50/503; H01M 50/507; H01M 2220/20

(57) ABSTRACT

The apparatus can include a busbar and a nut plate. The busbar can include a tab region. The tab region can define one or more openings. The nut plate can be configured to couple with the tab region of the busbar. One or more openings in the nut plate can align with the one or more openings of the tab region. The nut plate can have a planar shape. At least a portion of a face of the nut plate can couple with a planar face of the tab region of the busbar.

### INTRODUCTION

Batteries can be a source of electrical power. Various components or devices can be used to connect batteries and transfer current between batteries.

### SUMMARY

This technology is directed to providing a busbar assembly to resist forces applied to the busbar assembly and maintain alignment between a busbar and a nut plate of the busbar assembly, for example. A connection between a tab region of the busbar and the nut plate can reduce the probability of an opening of the tab region being misaligned with an opening of the nut plate and reduce the magnitude of a misalignment if it were to occur. The connection can be permanent or irreversible. For example, the nut plate can be riveted to the tab region of the busbar such that there is little if any movement between the nut plate and the tab region when an external force is applied to the busbar assembly. The riveted connection can keep the opening of the nut plate aligned with the opening of the tab region.

At least one aspect is directed to an apparatus. The apparatus can include a busbar and a nut plate. The busbar can include a tab region. The tab region can define one or more openings. The nut plate can be configured to couple with the tab region of the busbar. One or more openings in the nut plate can align with the one or more openings of the tab region. The nut plate can have a planar shape. At least a portion of a face of the nut plate can couple with a planar face of the tab region of the busbar.

At least one aspect is directed to a battery module assembly. The battery module assembly can include a module, a busbar, and a nut plate. The busbar can be configured to couple with the module. The busbar can have a tab region. The tab region can define one or more openings. The nut plate can be configured to couple with the tab region of the busbar. One or more openings in the nut plate can align with the one or more openings of the tab region. At least a portion of a face of the nut plate can couple with a face of the tab region of the busbar.

At least one aspect is directed to a method. The method can include aligning one or more openings of a nut plate with one or more openings of a busbar. The one or more openings of the busbar can be disposed on a tab region of the busbar. The method can include coupling the nut plate with the tab region of the busbar. At least a portion of a face of the nut plate can be configured to be flush with a face of the tab region of the busbar.

At least one aspect is directed to an electric vehicle. The electric vehicle can include a busbar assembly. The busbar assembly can include a busbar and a nut plate. The busbar can have a tab region. The tab region can define at least one opening to secure a connection between the busbar and an external element. The nut plate can couple with the tab region. An opening in the nut plate can align with the at least one opening of the tab region. The nut plate can have a planar shape. A face of the nut plate can be flush with a face of the tab region of the busbar.

At least one aspect is directed to a method. The method can include providing a busbar assembly. The busbar assembly can include a busbar and a nut plate. The busbar can have a tab region. The tab region can define an opening to secure a connection between the busbar and an external element. The nut plate can couple with the tab region of the busbar. An opening in the nut plate can align with the opening of the tab region. The nut plate can have a planar shape. A face of the nut plate can be configured to be flush with a face of the tab region of the busbar.

At least one aspect is directed to a method. The method can include assembling a busbar assembly. The method can include aligning at least one opening of a nut plate with at least one opening of a busbar. The one opening of the busbar can be disposed on a tab region of the busbar. The at least one opening of the busbar can secure a connection between the busbar and an external element. The method can include coupling the nut plate with the tab region of the busbar. The nut plate can have a planar shape. A face of the nut plate can be flush with a face of the tab region of the busbar. The method can include coupling the busbar assembly with at least one submodule.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example electric vehicle, in accordance with some aspects.

FIG. 2A depicts an example battery pack, in accordance with some aspects.

FIG. 2B depicts example battery modules, in accordance with some aspects.

FIG. 3 depicts an example busbar assembly, in accordance with some aspects.

FIG. 4 depicts an example tab region of a busbar assembly, in accordance with some aspects.

FIG. 5 depicts an example nut plate of a busbar assembly, in accordance with some aspects.

FIG. 6 depicts an example busbar assembly with an external element, in accordance with some aspects.

FIG. 7 depicts an example battery module assembly, in accordance with some aspects.

FIG. 8 depicts an example battery module assembly, in accordance with some aspects.

FIG. 9 depicts a flow diagram illustrating an example method to assemble a busbar assembly, in accordance with some aspects.

FIG. 10 depicts a flow diagram illustrating an example method to provide a busbar assembly, in accordance with some aspects.

FIG. 11 depicts a flow diagram illustrating an example method to assemble a battery module assembly, in accordance with some aspects.

### DETAILED DESCRIPTION

Following below are more detailed descriptions of various concepts related to, and implementations of, methods, apparatuses, and systems of or including a busbar with an integrated nut plate. The various concepts introduced above and discussed in greater detail below may be implemented in any of numerous ways.

The present disclosure is generally directed to a busbar with an integrated nut plate. A busbar and nut plate combination can be subject to forces and torques during assembly and installation that can cause misalignment among holes within the busbar and the nut plate. A misalignment between these two pieces can, for example, create a high electrical resistance which can generate heat, reduce the current carrying capabilities of the assembly, or provide a false torque reading when assembling the system.

To prevent or mitigate the effects of the forces and torques experienced by the busbar and the nut plate, this technical solution can provide a secure coupling between the busbar and the nut plate that can effectively reduce the probability of a misalignment and reduce a magnitude of a misalignment if it occurs. The busbar coupled with the nut plate can include a connection mechanism (e.g., rivets) that can resist the effects of forces being applied to the busbar or the nut plate. The type of connection mechanism, the location of the connection mechanism, the number of connection mechanisms, etc., can all affect the assembly's ability to resist the applied forces and torques.

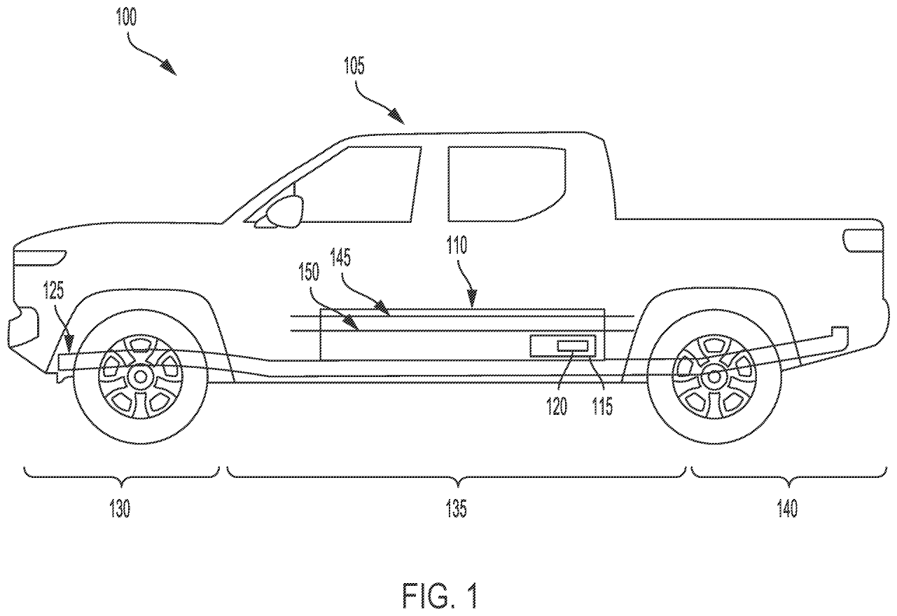

FIG. 1 depicts is an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

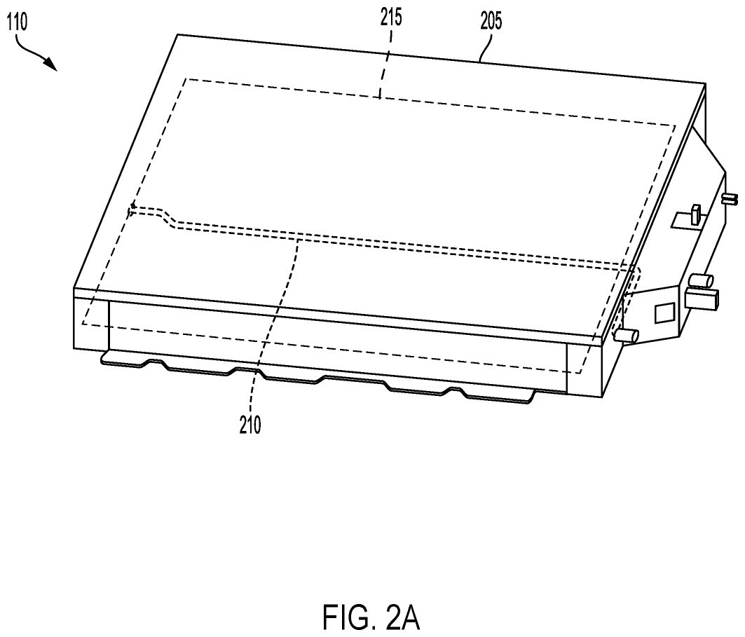

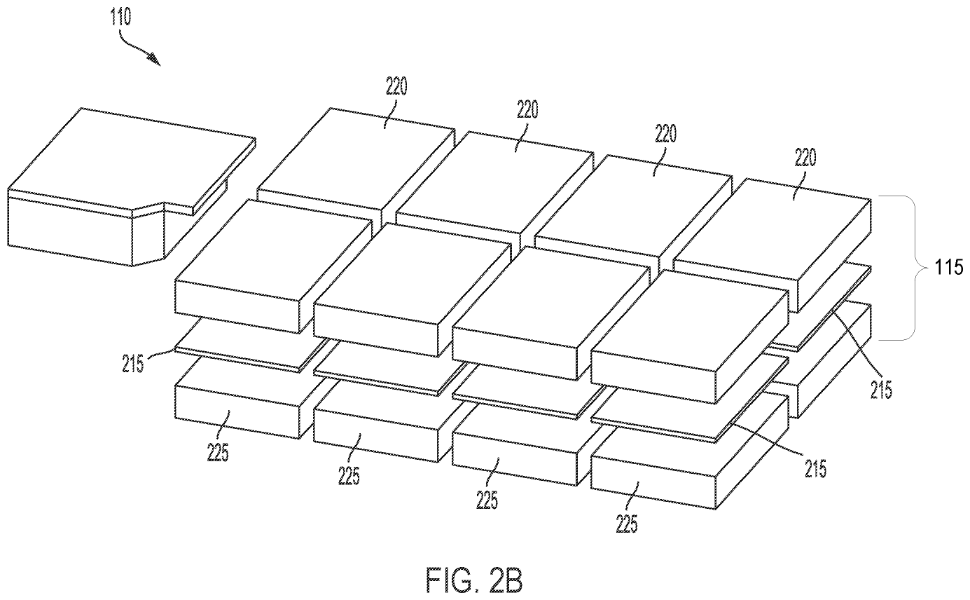

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The housing 205 can include a shield on the bottom or underneath the battery module 115 to protect the battery module 115 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one cold plate 215. The cold plate 215 can be positioned in relation to a top submodule and a bottom submodule, such as in between the top and bottom submodules, among other possibilities. The battery pack 110 can include any number of cold plates 215. For example, there can be one or more cold plates 215 per battery pack 110, or per battery module 115. At least one cooling line 210 can be coupled with, part of, or independent from the cold plate 215.

FIG. 2B depicts example battery modules 115. The battery modules 115 can include at least one submodule. For example, the battery modules 115 can include at least one top submodule 220 or at least one bottom submodule 225. At least one cold plate 215 can be disposed between the top submodule 220 and the bottom submodule 225. For example, one cold plate 215 can be configured for heat exchange with one battery module 115. The cold plate 215 can be disposed or thermally coupled between the top submodule 220 and the bottom submodule 225. One cold plate 215 can also be thermally coupled with more than one battery module 115 (or more than two submodules 220, 225). The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a cold plate 215 in between the top submodule 220 and the bottom submodule 225. The battery pack 110 can include or define a plurality of areas for positioning of the battery module 115. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120.

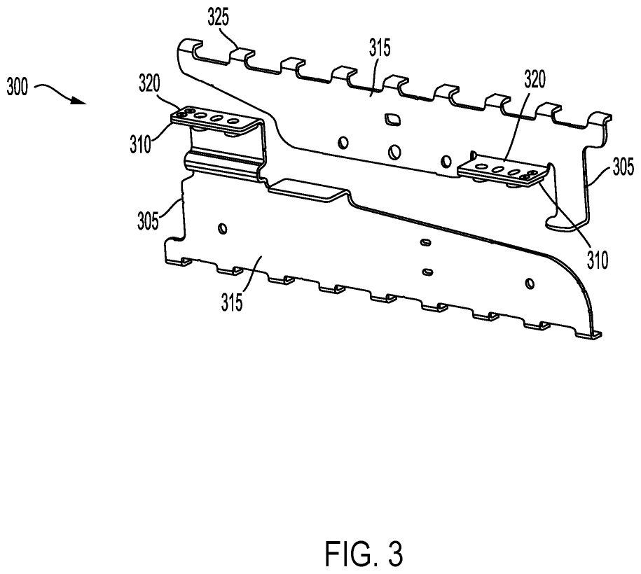

FIG. 3 depicts an example busbar assembly 300. Busbar assembly 300 can include at least one busbar 305 and at least one nut plate 310. Busbar 305 can be configured to carry current between components in a battery pack. For example, busbar 305 can comprise a conductive material such that current can pass from a first battery module to a second battery module through the busbar 305. The busbar 305 can carry current between a first battery cell and a second battery cell. Busbar 305 can include at least one body 315, at least one tab region 320, and at least one connector 325. Body 315 can be at least partially comprise a material that can carry current. For example, body 315 can be composed of copper, brass, aluminum, among other materials. Busbar 305 can be the same material throughout or can comprise a plurality of materials. For example, the body 315 can be a first material, the tab region 320 can be a second material, and the connector 325 can be a third material. In some examples, each component can comprise different materials. For example, a first portion of the body 315 can be a conductive material and a second portion can be a non-conductive material. The body 315 can comprise any material configured to retain a rigid shape. Body 315 can be any shape. For example, body 315 can be a flat strip, a solid bar, a rod, a hollow tube, etc. FIG. 3 depicts two different busbars 305 with different body shapes. A body 315 of a first busbar 305 can have a majority flat shape with a first geometry and a body 315 of a second busbar 305 can have a majority flat shape with a second geometry. Body 315 can comprise a majority of a planar shape. In some examples, body 315 can have a bump, curve, turn, bulge, crater etc. that extends into a different plane. Body 315 can be a solid shape or comprise one or more apertures for various functions (e.g., connection locations, locating features, passages for components to pass through, etc.). Referring to FIG. 1, among others, busbar 305 can be the same or different busbar than busbar 145, 150.

Connector 325 can be configured to couple the busbar 305 with a battery module. For example, connector 325 can be configured to snap on to, grip, interlock with, etc. the battery module such that the busbar 305 is coupled with the battery module. Connector 325 can also be configured to receive current from the battery module that is to be transferred through the busbar 305 or provide current to the battery module that has been transferred through the busbar 305. Other coupling mechanism can be used to couple the busbar 305 with the battery module.

Connector 325 can be disposed on at least one side of the busbar 305. For example, connector 325 can extend from an edge of the body 315 in a direction perpendicular or substantially perpendicular (e.g., +/−10°) with the body 315. In some examples, busbar 305 can include a plurality of connectors 325. The plurality of connectors 325 can extend from an edge of the busbar 305. For example, the plurality of connectors 325 extend from a bottom edge of the busbar 305. In some examples, the plurality of connectors 325 can extend from a plurality of edges of the busbar 305. For example, a first subset of the plurality of connectors 325 can extend from a first edge of the busbar 305 and second subset of the plurality of connectors 325 can extend from a second edge of the busbar 305. The plurality of connectors 325 can all extend in the same direction or different directions. For example, a first subset of the plurality of connectors 325 can extend in a first direction and a second subset of the plurality of connectors 325 can extend in a second direction.

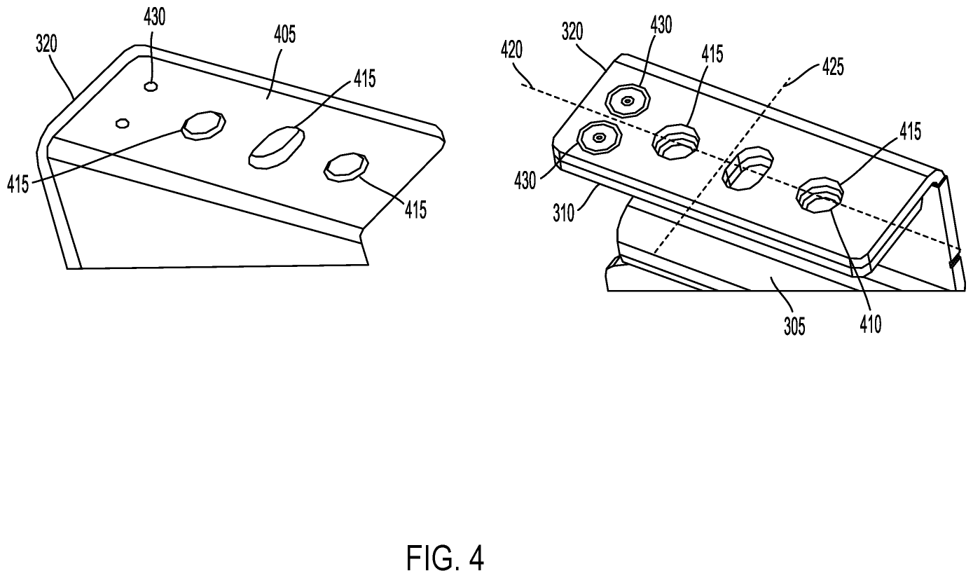

FIG. 4 depicts an example tab region 320. Tab region 320 of the busbar 305 can be configured to couple with the nut plate 310 of the busbar assembly 300. For example, tab region 320 can include a front face 405 and a back face 410. Front face 405 can have a flat surface. For example, the front face 405 can be a planar face. For example, the front face 405 can be disposed in a single plane. For example, front face 405 can include no disruptions (e.g., bumps, bends, curves, etc.). A face of the nut plate 310 can interface with the front face 405 of the tab region 320. Back face 410 can have a flat surface. For example, front face 405 and back face 410 can have different shapes, or the face of the nut plate 310 can have a mirrored shape such that the face of the nut plate 310 can couple with a non-planar face of the tab region 320. In some examples, front face 405 can include a locating feature that aligns with a locating feature of the nut plate 310 to ensure proper alignment of the tab region 320 with the nut plate 310.

Tab region 320 can extend from an edge of the body 315 of the busbar 305. For example, tab region 320 can extend substantially perpendicular from the body 315. For example, tab region 320 can extend ninety degrees from the body 315, plus or minus ten degrees. The tab region 320 can extend from the body 315 at other angles. For example, tab region 320 can be co-planar with the body 315 or the tab region 320 can extend at any angle from the body 315. A size of the tab region 320 or a shape of the tab region 320 can be based on the nut plate 310. For example, tab region 320 can be configured to be at least the size of the nut plate 310 such that an entire face of the nut plate interfaces with the tab region 320. For example, the front face 405 of the tab region 320 can be the same or substantially (e.g., +/−10%) the same size as a face of the nut plate 310 such that the front face 405 can interface with the entire face of the nut plate 310. For example, at least a portion of a perimeter of the tab region 320 can align with a portion of a perimeter of the nut plate 310. For example, as shown in FIG. 4, among others, three edges of the tab region 320 can align with three edges of the nut plate 310. The front face 405 can be configured to interface with only a portion of the face of the nut plate 310. For example, the front face 405 can be smaller than the face of the nut plate 310 and be configured to only interface with a portion of the nut plate 310.

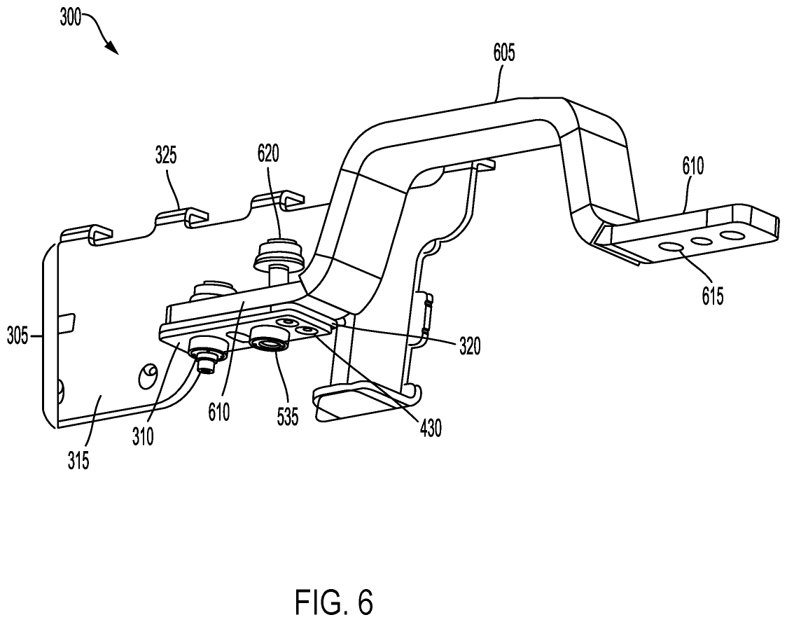

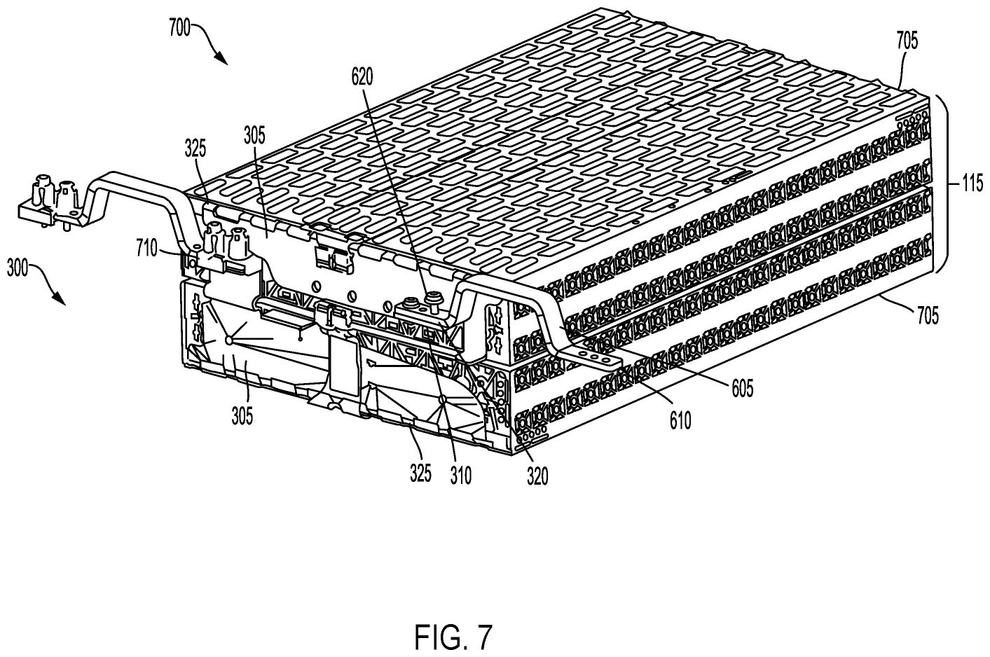

Tab region 320 can define at least one opening 415. The opening 415 can extend from the front face 405 to the back face 410. Opening 415 can be configured to receive a fastener to secure an external element to the busbar assembly 300. For example, opening 415 can receive a bolt configured to couple a jumper busbar to the busbar 305. The opening 415 can also be configured to receive a locking pin of an isolation cover. The jumper busbar and the isolation cover are discussed in more detail below with reference to FIGS. 6 and 7, among others. Tab region 320 can define a plurality of openings 415. The plurality of openings 415 can all be the same size and shape and provide the same function. For example, the tab region 320 can include a first opening 415 configured to receive a bolt and a second opening configured to receive another bolt. The plurality of openings 415 can have a plurality of shapes, sizes, functions, etc. For example, a first opening 415 can be configured to receive a bolt and a second opening 415 can be configured to receive a locking pin.

The opening 415 can be disposed centrally on the tab region 320. For example, the opening 415 can be disposed along a longitudinal centerline 420 and a lateral centerline 425 of the tab region 320. For example, a center of the opening 415 can pass through the longitudinal centerline 420 and the lateral centerline 425. The opening 415 can be offset from at least one of the centerlines 420, 425. For example, opening 415 can be centered with respect to the longitudinal centerline 420 and offset with respect to the lateral centerline 425. In some examples, the opening 415 can be offset from both centerlines 420, 425. With a plurality of openings 415, the plurality of openings 415 can be arranged in any pattern. For example, the plurality of openings 415 can be arranged in a straight line, staggered in uniform pattern, or disposed randomly on the tab region 320, among other patterns. For example, tab region 320 can include a first opening 415, a second opening 415, and a third opening 415. The first, second, and third openings 415 can be centered along the longitudinal centerline 420 with the first opening 415 centered along the lateral centerline 425 and the second and third openings 415 disposed equidistant from the lateral centerline 425 but on opposite sides. The first, second, and third openings 415 can be centered along the longitudinal centerline 420 with the first opening 415 offset from the lateral centerline 425 in a first direction and the second and third openings 415 offset from the lateral centerline 425 in a second direction.

Busbar assembly 300 can include at least one connection point 430 at which the nut plate 310 can couple with the tab region 320. The connection point 430 can be a location at which the tab region 320 is coupled with the nut plate 310. Connection point 430 can an irreversible or permanent connection. For example, the connection point 430 can include a rivet. A nut plate 310 coupled with a tab region 320 via a rivet cannot be undone or removed without breaking the fastener (e.g., the rivet) or a component that is being coupled (e.g., the nut plate 310 or the tab region 320). Other fasteners can also be used to permanently couple the nut plate 310 with the tab region 320, including but not limited to nails, adhesives, welds, solders, etc. For example, a nail can be a single-use fastener configured to maintain the coupling. The busbar assembly 300 can have a plurality of connection points 430. For example, a first connection point 430 and a second connection point 430 can be used to couple the nut plate 310 with the tab region 320. The first and second connection points 430 can include the same type of fastener or can be different types of fasteners. For example, both the first and second connection points 430 can include rivets. The first connection point 430 can also include a rivet and the second connection point 430 can include a nail.

The plurality of connection points 430 can be disposed on a single side of the tab region 320. For example, a first and second connection point 430 can be on the same side of the lateral centerline 425. For example, the first and second connection points 430 can be disposed proximate to a side edge of the tab region 320. For example, the first and second connection points 430 can be disposed closer to a lateral edge of the tab region 320 than the lateral centerline 425. In such an example, the first and second connection points 430 can be positioned symmetrically from the longitudinal centerline 420. For example, the first connection point 430 can be disposed on a first side of the longitudinal centerline 420 and a distance away from the longitudinal centerline 420. The second connection points 430 can be disposed on a second side of the longitudinal centerline 420 and the same distance away from the longitudinal centerline 420. The plurality of connection points 430 can be disposed on opposite sides of the tab region 320. For example, a first connection point 430 can be on a first side of the lateral centerline 425 and a second connection point 430 can be on a second side of the lateral centerline 425. The first connection point 430 can be proximate to a first edge of the tab region 320 and the second connection point 430 can be proximate to an opposing edge of the tab region 320. In such an example, the first and second connection points 430 can be disposed along the longitudinal centerline 420. The first and second connection points 430 can be disposed closer to the lateral centerline 425 than the edges of the tab region 320. The plurality of connection points 430 can be disposed asymmetrically along the tab region 320.

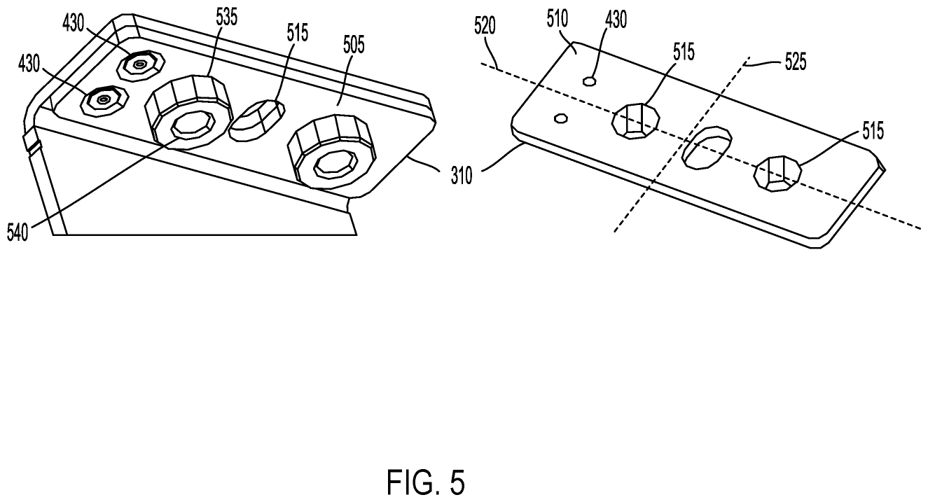

FIG. 5 depicts an example nut plate 310. Nut plate 310 can have a front face 505 and a back face 510. Nut plate 310 can have a planar shape. For example, nut plate 310 can have a flat shape. Nut plate 310 can comprise no bends, curves, etc. For example, the front face 505 can have a flat surface such that the front face 505 is on a single plane. The nut plate 310 can be disposed in a single plane. The nut plate 310 can have a substantially rectangular shape. For example, nut plate 310 can have a first set of opposing sides with a first length and a second set of opposing sides with a second length. The sides of each set of opposing sides can be parallel.

Nut plate 310 can include at least one opening 515. The opening 515 can extend from the front face 505 to the back face 510. Opening 515 can be configured to receive a fastener to secure an external element to the busbar assembly 300. For example, opening 515 can be configured to receive a bolt configured to couple a jumper busbar to the busbar 305. The opening 515 can be configured to receive a locking pin of an isolation cover. Nut plate 310 can define a plurality of openings 515. The plurality of openings 515 can all be the same size and shape and provide the same function. For example, the nut plate 310 can include a first opening 515 configured to receive a bolt and a second opening configured to receive another bolt. The plurality of openings 515 can have a plurality of shapes, sizes, functions, etc. For example, a first opening 515 can be configured to receive a bolt and a second opening 515 can be configured to receive a locking pin.

Nut plate 310 can include at least one projection 535. Projection 535 can be configured to receive a fastener. For example, an internal cavity 540 of projection 535 can be threaded to receive a screw. Projection 535 can be an extension of opening 515 wherein the internal cavity 540 aligns with opening 515 such that opening 515 can extend from a back face 510 of the nut plate 310 through the projection 535.

At least one opening 515 of the nut plate 310 can be configured to align with at least one opening 415 of the tab region 320. Nut plate 310 can include a plurality of openings 515. The plurality of openings 515 can be configured to align with a plurality of openings 415 of the tab region 320. For example, nut plate 310 can include a first opening 515 and a second opening 515. First opening 515 can be configured to align with a first opening 415 of the tab region 320 and the second opening 515 can be configured to align with a second opening 415 of the tab region 320. A subset of the plurality of openings 515 of the nut plate 310 can be configured to align with opening(s) 415 of the tab region 320. For example, nut plate 310 can include a first opening 515 and a second opening 515. The first opening 515 can be configured to align with an opening 415 of the tab region 320 and the second opening 515 can be configured to not align with an opening of the tab region 320. The opening 515 of the nut plate 310 can be the same size as the opening 415 of the tab region 320. For example, a perimeter of the opening 515 can align with a perimeter of the opening 415. For example, when aligned, there is no offset between opening 415 and opening 515 such that a smooth surface extends through the openings 415, 515 from a front face 505 of the nut plate to a back face 410 of the tab region 320.

Similar to the description of the tab region 320, a location of the opening 515 on the nut plate 310 can vary. For example, the opening 515 can be disposed centrally on the nut plate 310. For example, the opening 515 can be disposed along a longitudinal centerline 520 and a lateral centerline 525 of the nut plate 310. For example, a center of the opening 515 can pass through the longitudinal centerline 520 and the lateral centerline 525. The opening 515 can be offset from at least one the centerlines 520, 525. For example, the opening 515 can be centered with respect to the longitudinal centerline 520 and offset with respect to the lateral centerline 525. In some examples, the opening 515 can be offset from both centerlines 520, 525. With a plurality of openings 515, the plurality of openings 515 can be arranged in any pattern. For example, the plurality of openings 515 can be arranged in a straight line, staggered in uniform pattern, or disposed randomly on the nut plate 310, among other patterns. The arrangement of the plurality of openings 515 of the nut plate 310 can be based on an arrangement of a plurality of openings 415 of the tab region 320. The size, shape, and type of openings 515 can also be based on the plurality of openings 415 of the tab region 320. The size, shape, type, and arrangement of the opening(s) 415 of the tab region 320 can be based on the size, shape, type, and arrangement of the opening(s) 515 of the nut plate 310.

Nut plate 310 can be configured to couple with the tab region 320 of busbar 305. For example, nut plate 310 can couple with the tab region 320 via the at least one connection point 430. The connection point 430 can be a location at which the nut plate 310 is coupled with the tab region 320. Connection point 430 shown on the nut plate 310 can align with the connection point 430 shown on the tab region 320. As explained with respect to FIG. 4, connection point 430 can include a rivet. For example, nut plate 310 can be coupled with tab region 320 via at least one connection point 430. The at least one connection point 430 can be an irreversible or permanent connection (e.g., a rivet). For example, a nut plate 310 coupled with a tab region 320 via a rivet cannot be undone or removed without breaking the fastener (e.g., the rivet) or a component that is being coupled (e.g., the nut plate 310 or the tab region 320). Other fasteners can also be used to permanently couple the nut plate 310 with the tab region 320, including but not limited to nails, adhesives, welds, solders, etc.

The busbar assembly can have a plurality of connection points 430. For example, the nut plate 310 can be irreversibly coupled with the tab region 320 of the busbar 305 by at least two connection points 430. For example, a first connection point 430 and a second connection point 430 can be used to couple the nut plate 310 with the tab region 320. The first and second connection points 430 can be the same type of fastener or can be different types of fasteners. For example, both the first and second connection points 430 can be rivets. The first connection point 430 can be a rivet and the second connection point 430 can be a nail. The first connection point 430 can be disposed on a first side of the longitudinal centerline 520 of the nut plate 310 and the second connection point 430 can be disposed on a second side of the longitudinal centerline 520 of the nut plate 310. The first connection point 430 and the second connection point 430 can be disposed a distance away from the longitudinal centerline 520. For example, the first and second connection points 430 can be disposed the same distance away from the longitudinal centerline 520. The first and second connection points 430 can be disposed different distances away from the longitudinal centerline 520. The first and second connection points 430 can be disposed on the same side of the nut plate 310. For example, the first and second connection points 430 can be disposed on a first side of the lateral centerline 525 of the nut plate 310. The first and second connection points 430 can be disposed the same distance away from the lateral centerline 525 or can be disposed different distances away from the later centerline 525. In some examples, the first and second connection points 430 can be disposed closer to an edge of the nut plate 310 than the lateral centerline 525. The first and second connection points 430 can be disposed closer to the lateral centerline 525 than the edge of the nut plate 310.

The connection points 430 of the nut plate 310 and the tab region 320 can maintain the nut plate 310 in a desired position with respect to the tab region 320. For example, a permanent coupling can ensure an opening 415 of the tab region 320 remains aligned with an opening 515 of the nut plate 310. The connection points 430 can provide resistance to an external force applied to the busbar assembly 300. For example, the connection points 430 can prevent a misalignment between the opening 415 of the tab region 320 and the opening 515 of the nu plate 310. For example, when inserting a fastener through aligned openings 415, 515, the force (e.g., torque) applied to the fastener can cause the nut plate 310 and the tab region 320 to become misaligned. However, connection points 430 provide resistance to the external force and keep the openings 415, 515 aligned. For example, connection points 430 can keep the openings 415, 515 aligned within three millimeters of each other. For example, three millimeters can be a maximum offset experienced by the openings 415, 515 when the nut plate 310 and the tab region 320 are irreversibly coupled. This maximum offset can also be greater than three millimeters.

The size of the nut plate 310 can be based on a size of the tab region 320. For example, at least a portion of a perimeter of the nut plate 310 can be configured to align with a portion of a perimeter of the tab region 320. For example, as shown in FIG. 5 among others, three sides of the nut plate 310 can align with three sides of the tab region 320. For example, a first lateral edge of the nut plate 310 can align with a first lateral edge of the tab region 320, a second lateral edge of the nut plate 310 can align with a second lateral edge of the tab region 320, and a longitudinal edge of the nut plate can align with a longitudinal edge of the tab region 320. In some examples, fewer edges are aligned or more edges are aligned. The nut plate 310 can be a different shape or size than the tab region 320. For example, the nut plate 310 can be larger or smaller than the tab region 320 of the busbar 305. For example, the nut plate 310 can be larger than the tab region 320 such that a portion of the back face 510 of the nut plate 310 can be coupled with a planar face (e.g., the front face 405) of the tab region 320 of the busbar 305. The back face 510 can be flush with the planar face of the tab region 320. For example, the back face 510 of the nut plate 310 can be level or even with the planar face of the tab region 320 when interfacing with the face of the planar tab region 320.

In one example, the back face 510 of the nut plate 310 can interface with a front face 405 of the tab region 320. For example, the front face 405 of the tab region 320 can have a planar surface (e.g., flat surface). The back face 510 of the nut plate 310 can have a planar surface. The nut plate 310 can be coupled with the tab region 320 such that at least a portion of the back face 510 of the nut plate 310 can interface with a portion of the front face 405 of the tab region 320. In some examples, the entire back face 510 of the nut plate 310 can interface with the front face 405 of the tab region 320. A portion of a perimeter of the nut plate 310 can align with a portion of a perimeter of the tab region 320 of the busbar 305. For example, at least one edge of the nut plate 310 can align with an edge of the tab region 320. For example, a first lateral edge of the nut plate 310 can align with a first lateral edge of the tab region 320. In some examples, a plurality of edges of the nut plate 310 can align with a plurality of edges of the tab region 320. For example, a first and second lateral edge of the nut plate 310 can align with a first and second lateral edge of the tab region 320 and a longitudinal edge of the nut plate 310 can align with a longitudinal edge of the tab region 320. In some examples, no edges of the nut plate 310 align with edges of the tab region 320.

The nut plate 310 can be coupled with the tab region 320 via at least one connection point 430. The at least one connection point 430 can correspond with a connection point 430 of the tab region 320. In some examples, the nut plate 310 and the tab region 320 have a plurality of connection points 430 including a first connection point 430 and a second connection point 430. The first and second connection points 430 can be disposed on the same side of the lateral centerline 525. The first and second connection points 430 can be disposed closer to an edge of the nut plate 310 than the lateral centerline 525. The first and second connection points 430 can be disposed the same distance away from the longitudinal centerline 520.

The nut plate 310 can include a plurality of openings 515. The tab region 320 can include a plurality of corresponding openings 415. For example, the openings 515 of the nut plate 310 can align with openings 415 of the tab region. For example, the nut plate 310 can include a first opening 515, a second opening 515, and a third opening 515. The first and second openings 515 can be configured to receive a first fastener to secure a first external element to the busbar assembly 300. The third opening 515 can be configured to receive a second fastener to secure a second external element to the busbar assembly 300. The external elements can include a jumper busbar, isolation cover, etc. The tab region 320 can include a plurality of openings 415 to align with the first, second, and third openings of the nut plate 310. For example, the first fastener can extend though the first opening of the nut plate 310 and a first opening 415 of the tab region 320.

FIG. 6 depicts an example busbar assembly 300 coupled with an external element. External element can be a jumper busbar 605. A jumper busbar 605 can be configured to transfer current. For example, jumper busbar 605 can be configured to couple with a plurality of battery modules. The jumper busbar 605 can transfer current between the plurality of battery modules. Jumper busbar 605 can include an end portion 610. End portion 610 can be configured to couple with the busbar assembly 300 via the tab region 320 and the nut plate 310. For example, end portion 610 of the jumper busbar 605 can include at least one opening 615 to align with an opening 415 of the tab region 320 and an opening 515 of the nut plate 310. A flat surface of the end portion 610 can interface with a planar surface of the tab region 320. For example, the end portion 610 can interface with the back face 410 of the tab region 320. A fastener 620 can be configured to extend through the aligned openings 415, 515, 615 to couple the jumper busbar 605 with the busbar assembly 300. For example, a bolt can extend through the openings 415, 515, 615 and secure the jumper busbar 605 in place with respect to the busbar assembly 300. Fasteners 620 can be or include other types of fasteners, including but not limited to rivets, screws, or nails, for example.

Jumper busbar 605 can include a plurality of end portions 610. For example, jumper busbar 605 can include a first end portion 610 and a second end portion 610. The first end portion 610 can be configured to couple with a first busbar assembly 300 coupled with a first battery module and the second end portion 610 can be configured to couple with a second busbar assembly 300 coupled with a second battery module.

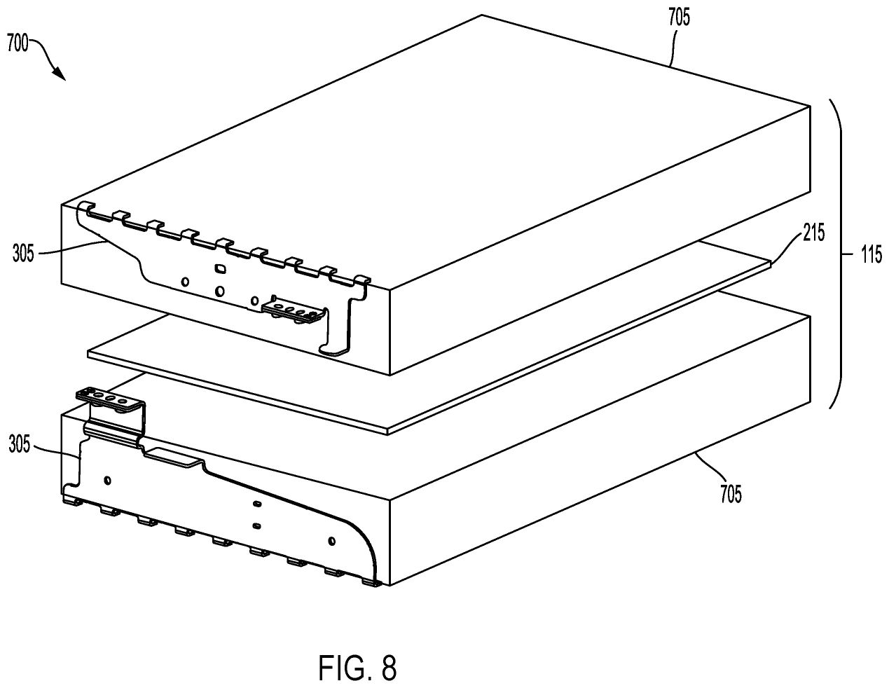

FIG. 7 depicts an example battery module assembly 700. Battery module assembly 700 can include a busbar assembly 300 and a battery module 115. Battery module 115 can include a plurality of submodules 705. For example, battery module 115 can include a first submodule 705 and a second submodule 705. The first submodule 705 can be disposed above the second submodule 705. For example, the second submodule 705 can support the first submodule 705. In some examples, a cold plate 215 can be disposed between the first and second submodules 705 (as shown in FIG. 8, among others). The busbar assembly 300 can include at least one busbar 305 and at least one nut plate 310. The busbar 305 can include a tab region 320. The tab region 320 can define at least one opening 415. The busbar 305 can be configured to couple with the battery module 115. For example, busbar 305 can include at least one connector 325. The connector 325 can be configured to secure the busbar 305 with the battery module 115. The nut plate 310 can define at least one opening 515. The opening 515 of the nut plate 310 can be configured to align with the opening 415 of the tab region 320 of the busbar 305. The nut plate 310 can be configured to couple with the tab region 320 of the busbar 305. For example, the nut plate 310 can couple with the tab region 320 via at least one connection point 430. The at least one connection point 430 can include an irreversible connection. For example, the irreversible connection can include a rivet. The nut plate 310 can have a planer shape. For example, the nut plate 310 can be flat. At least a portion of a face of the nut plate 310 can be configured to be flush with a face of the tab region 320. In some examples, the entire face of the nut plate 310 can be configured to be flush with a face of the tab region 320.

The nut plate 310 can be irreversibly coupled with the tab region 320 by at least two connection points 430. For example, the nut plate 310 can be irreversibly coupled with the tab region 320 by a first connection point 430 and a second connection point 430. In one example, the first and second connection points 430 can be disposed on a first side of the nut plate 310. For example, the first and second connection points 430 can be disposed on the same side of a lateral centerline 525 of the nut plate 310. The first and second connection points 430 can be irreversible connections points. For example, the first and second connection points 430 can be a rivet, a weld, a solder. The first and second connection points 430 can be disposed closer to an edge of the nut plate 310 than the lateral centerline 525. The first connection point 430 can be disposed on a first side of a longitudinal centerline 520 of the nut plate 310 and the second connection point 430 can be disposed on a second side of the longitudinal centerline 520 of the nut plate 310. The first and second connection points 430 can be disposed the same distance away from the longitudinal centerline 520. A portion of a perimeter of the nut plate 310 can align with a portion of a perimeter of the tab region 320. For example, at least one edge of the nut plate 310 can align with at least one edge of the tab region 320.

The busbar assembly 300 can include a plurality of busbars 305. For example, a first busbar 305 and a second busbar 305 can couple with the battery module 115. For example, the first busbar 305 can couple with the first submodule 705 and the second busbar 305 can couple with the second submodule. The busbars 305 can be the same shape or different shapes. The busbars 305 can be disposed on the same side of the battery module 115. For example, the first busbar 305 and the second busbar 305 can be disposed on a front side of the battery module 115. The first busbar 305 and the second busbar 305 can be at least partially disposed in the same vertical plane when coupled with the battery module 115.

The busbar assembly 300 can include a plurality of nut plates 310. For example, the busbar assembly 300 can include a first nut plate 310 and a second nut plate 310. The first and second nut plates 310 can have a planar shape. For example, the first and second nut plates 310 can be disposed on a single plane (e.g., flat, level). The first busbar 305 can be coupled with the first nut plate 310 to form a first busbar assembly 300 and the second busbar 305 can be coupled with the second nut plate 310 to form a second busbar assembly 300. The first busbar assembly 300 can couple with the first submodule 705 and the second busbar assembly 300 can couple with the second submodule 705.

The battery module 115 can be a first battery module 115 of a battery pack 110. The first busbar 305 can be configured to electrically couple the first battery module 115 with a second battery module 115 of the battery pack 110. The second busbar 305 can be configured to electrically couple the first battery module 115 with a third battery module 115 of the battery pack 110. For example, the first busbar 305 can couple with a jumper busbar 605. A first busbar assembly 300 can be coupled with a first battery module 115. A first end portion 610 of jumper busbar 605 can couple with the tab region 320 and the nut plate 310 of the first busbar assembly 300. For example, a fastener 620 can extend though openings 415, 515, 615 of the tab region 320, nut plate 310, and the jumper busbar 605 respectively to secure the jumper busbar 605 to the first busbar assembly 300. A second busbar assembly 300 can be coupled with a second battery module 115. A second end portion 610 of jumper busbar 605 can couple with the tab region 320 and nut plate 310 of the second busbar assembly 300. For example, a fastener 620 can extend though openings 415, 515, 615 of the tab region 320, nut plate 310, and the jumper busbar 605 respectively to secure the jumper busbar 605 to the second busbar assembly 300.

Busbar assembly 300 can be configured to couple with other external elements, such as cover 710. At least one fastener 620 can be disposed within cover 710. Cover 710 can be configured to position the fastener 620 in place such that the fastener 620 aligns with the openings 415, 515, 615 prior to entering the openings 415, 515, 615. Cover 710 can couple with the nut plate 310, tab region 320, and the end portion 610 of the jumper busbar 605. For example, cover 710 can snap into place with the nut plate 310, tab region 320, and the end portion 610 of the jumper busbar 605. For example, cover 710 can include a protrusion configured to extend through aligned openings 415, 515, 615. The protrusion can act as a locating device to position the cover 710 in an appropriate position and act as a fastener to secure the cover 710 in place. With the cover 710 and at least one fastener 602 in the appropriate position, a tool can be used to move the at least one fastener 620 from a first position to a second position. The first position can include the fastener 620 disposed within the cover 710 and the second position can include the fastener 620 in a secured position extending through the openings 415, 515, 615 and securing the jumper busbar 605 to the busbar assembly 300.

The coupling of the nut plate 310 with the tab region 320 for the busbar 305 can provide a resistance to the forces applied when moving the fastener 620 from the first position to the second position. For example, a torque can be applied to the fastener 620 to move the fastener 620 through the openings 415, 515, 615 to couple the jumper busbar 605 with the busbar assembly 300. The torque can be transferred to the nut plate 310 and the tab region 320 such that the openings 415, 515 become misaligned. However, the irreversible coupling at the connection points 430 of the tab region 320 and the nut plate 310 can prevent the nut plate 310 from moving with respect to the tab region 320 and keep the openings 415, 515 aligned.

FIG. 8 depicts example battery module assembly 700. As explained above with reference to FIG. 2A, a battery pack 110 can include at least one cold plate 215. For example, as shown in FIG. 8 among others, a battery module 115 can include a cold plate 215. A battery pack 110 with a plurality of battery modules 115 can include a plurality of cold plates 215. A battery pack 110 with a plurality of battery modules 115 can include a single cold plate 215 to provide thermal control for all the battery modules 115. The cold plate 215 can be a thin piece of material disposed between a first submodule 705 and a second submodule 705 of the battery module 115. Battery module assembly 700 can include a first busbar 305 coupled with a first submodule 705 and a second busbar 305 coupled with a second submodule 705.

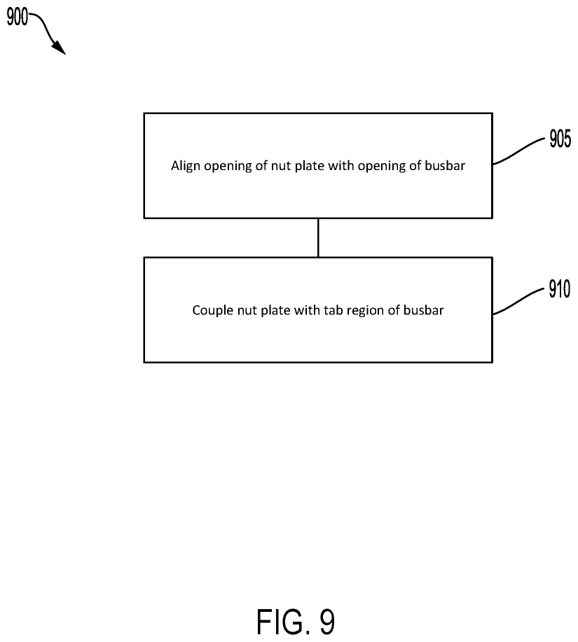

FIG. 9 depicts a flow diagram of an example method 900. Method 900 can be a method of assembling a busbar assembly 300. Method 900 can include aligning an opening of a nut plate with an opening of a busbar 905 and coupling the nut plate with a tab region of the busbar 910. Act 905 of aligning an opening of the nut plate with an opening of the busbar can include identifying an opening 415 of a busbar 305. The opening 415 can be disposed on a tab region 320 of the busbar 305. Act 905 can include identifying a corresponding opening 515 of a nut plate 310. Aligning the opening 415 of the tab region 320 of the busbar 305 with the corresponding opening 515 of the nut plate 310 can include adjusting a position of the nut plate 310 with respect to the tab region 320 until a perimeter of the openings 415, 515 align. For example, a shape and size of the opening 415 of the tab region 320 can be the same shape and size of the opening 515 of the nut plate 310. The openings 415, 515 can align such that a smooth transition is created between the nut plate 310 and the tab region 320 inside the openings 415, 515. For example, the smooth transition can include no steps, offsets, or other misalignments where the opening 415 of the tab region 320 meets the opening 515 of the nut plate 310. A plurality of openings 415 of the tab region 320 can align with a plurality of openings 515 of the nut plate 310.

Act 910 of coupling a nut plate with a tab region of a busbar can include coupling nut plate 310 with tab region 320 of busbar 305 such that the nut plate 310 cannot move with respect to the tab region 320. Coupling the nut plate 310 with the tab region 320 can include coupling by at least one connection point 430. The connection point 430 can be an irreversible connection. For example, the connection point 430 can include a rivet. The irreversible connection can be configured to secure a position of a cold plate 215 with respect to a first submodule 705 of a battery module 115 and a second submodule 705 of the battery module 115.

The nut plate 310 can have a planar shape. For example, the nut plate 310 can be disposed on a single plane. The nut plate 310 can have a flat face. Coupling the nut plate 310 with the tab region 320 can include interfacing the planar face of the nut plate 310 with a planar face of the tab region 320. At least a portion of the face of the nut plate 310 can be flush with the planar face of the tab region 320. In some examples, the entire face of the nut plate 310 can be flush with the planar face of the tab region 320.

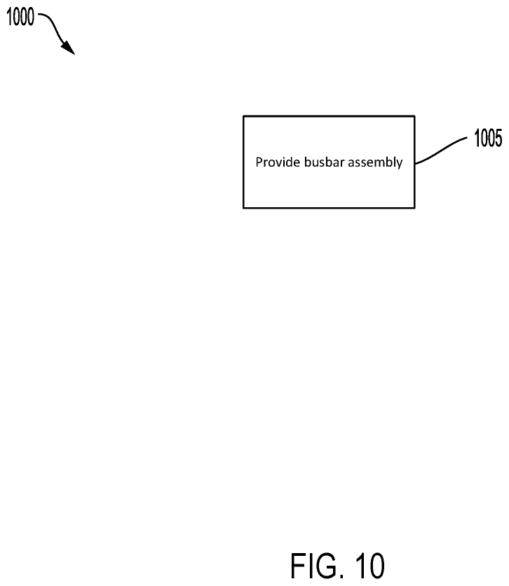

FIG. 10 depicts a flow diagram of an example method 1000. Method 1000 can be a method of providing a busbar assembly 300. Method 1000 can include providing a busbar assembly 1005. Act 1005 of providing a busbar assembly can include providing busbar assembly 300. Providing busbar assembly 300 can include providing at least one busbar 305 coupled with at least one nut plate 310. The busbar 305 can include a tab region 320. The tab region 320 can define an opening 415. The nut plate 310 can be coupled with a tab region 320 of the busbar 305. The nut plate 310 can be coupled with the tab region 320 via at least one connection point 430. The at least one connection point 430 can include an irreversible connection. For example, the at least one connection point 430 can include a rivet. The busbar assembly 300 can include at least one opening 415 of the tab region 320 aligned with at least one opening 515 of the nut plate 310. The nut plate 310 can have a planar shape. At least a portion of a face of the nut plate 310 can interface with a face of the tab region 320. For example, the portion of the face of the nut plate 310 can be flush with the face of the tab region 320. For example, the face of the nut plate 310 can be level or even with the face of the tab region 320 when interfacing with the face of the tab region 320. In some examples, the entire face of the nut plate 310 can interface with the face of the tab region 320. The opening 415 of the tab region 320 can be configured to secure a connection between the busbar 305 and an external element. For example, the opening 415 of the tab region 320 can secure a connection between the busbar 305 and a jumper busbar 605, a cover 710, among other external elements.

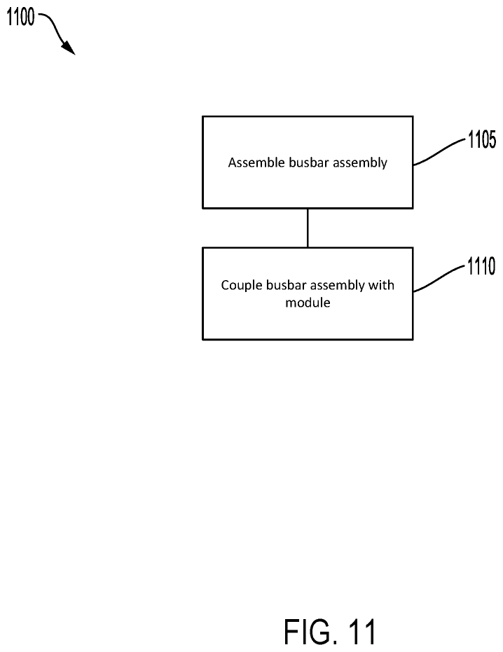

FIG. 11 depicts a flow diagram of an example method 1100. Method 1100 can be a method of assembling a battery module assembly 700. Method 1100 can include assembling a busbar assembly 1105 and coupling the busbar assembly with a module 1110. Act 1105 of assembling a busbar assembly can include aligning an opening 515 of a nut plate 310 with an opening 415 of a busbar 305 and coupling the nut plate with the busbar 305. The opening 415 of the busbar 305 can be disposed on a tab region 320 of the busbar 305. The opening 415 of the busbar 305 can be configured to secure a connection between the busbar 305 and an external element. For example, the opening 415 of the tab region 320 can secure a connection between the busbar 305 and a jumper busbar 605, a cover 710, among other external elements. The nut plate 310 can have a planar shape. A face of the nut plate 310 can be configured to be flush with a face of the tab region 320 of the busbar 305.

Act 1110 of coupling the busbar assembly with a module can include coupling a busbar assembly 300 with a battery module 115. For example, busbar assembly 300 can couple with battery module 115 via at least one connector 325 of the busbar 305. In some examples, the busbar assembly 300 can couple with a submodule 705 of the battery module 115. For example, the busbar assembly 300 can couple with a first submodule 705. In some examples, a plurality of busbar assemblies 300 can couple with the battery module 115. For example, a first busbar assembly 300 can couple with a first submodule 705 and a second busbar assembly 300 can couple with a second submodule 705.

Some of the description herein emphasizes the structural independence of the aspects of the system components or groupings of operations and responsibilities of these system components. Other groupings that execute similar overall operations are within the scope of the present application. The systems described above can provide multiple of any or each of those components and these components can be provided on either a standalone system or on multiple instantiations in a distributed system.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a busbar comprising a tab region defining one or more openings; and
a nut plate configured to couple with the tab region of the busbar, one or more openings in the nut plate to align with the one or more openings of the tab region, the nut plate having a planar shape, at least a portion of a face of the nut plate coupled with a planar face of the tab region of the busbar.

2. The apparatus of claim 1, comprising:
the face of the nut plate configured to be flush with the planar face of the tab region;
the nut plate coupled with the tab region of the busbar by at least one connection point, the at least one connection point to include a rivet.

3. The apparatus of claim 1, comprising:
the nut plate to irreversibly couple with the tab region of the busbar by at least two connection points, a first connection point disposed on a first side of a centerline of the nut plate and a second connection point disposed on a second side of the centerline of the nut plate, the first connection point and the second connection point disposed a distance away from the centerline.

4. The apparatus of claim 1, comprising:
the nut plate coupled with the tab region of the busbar by at least one connection point, the at least one connection point to include an irreversible connection, the irreversible connection configured to prevent a misalignment between the one or more openings in the nut plate and the one or more openings of the busbar.

5. The apparatus of claim 1, comprising:
the nut plate irreversibly coupled with the tab region of the busbar by at least two connection points, the at least two connection points disposed on a first side of the nut plate.

6. The apparatus of claim 1, comprising:
the nut plate irreversibly coupled with the tab region of the busbar by at least two connection points;
a first connection point of the at least two connection points disposed on a side of a first centerline and a second connection point of the at least two connection points disposed on the side of the first centerline, the first and second connection points disposed a first distance away from the first centerline; and
the first connection point disposed on a first side of a second centerline and the second connection point disposed on a second side of the second centerline, the first and second connection points disposed a second distance away from the second centerline.

7. The apparatus of claim 1, comprising:
a portion of a perimeter of the tab region of the busbar aligns with a portion of a perimeter of the nut plate.

8. The apparatus of claim 1, comprising:
a first lateral edge of the nut plate aligns with a first lateral edge of the tab region and a second lateral edge of the nut plate aligns with a second lateral edge of the tab region.

9. A battery module assembly, comprising:
a module;
a busbar configured to couple with the module, the busbar having a tab region, the tab region defining one or more openings; and
a nut plate configured to couple with the tab region of the busbar, one or more openings in the nut plate to align with the one or more openings of the tab region, at least a portion of a face of the nut plate coupled with a face of the tab region of the busbar.

10. The battery module assembly of claim 9, comprising:
a first submodule and a second submodule, the first submodule disposed above the second submodule, the second submodule configured to support the first submodule.

11. The battery module assembly of claim 9, comprising:
a first submodule and a second submodule;
a plurality of busbars including a first busbar and a second busbar; and
a plurality of nut plates including a first nut plate and a second nut plate, the first nut plate and the second nut plate comprising a planar shape;
the first busbar and the first nut plate to form a first busbar assembly, the first busbar assembly to couple with the first submodule; and
the second busbar and the second nut plate to form a second busbar assembly, the second busbar assembly to couple with the second submodule.

12. The battery module assembly of claim 9, comprising:
the nut plate to have a planar shape, the face of the nut plate configured to be flush with the face of the tab region of the busbar; and
the nut plate coupled with the tab region of the busbar by at least one connection point, the at least one connection point to include a rivet.

13. The battery module assembly of claim 9, comprising:
the nut plate to irreversibly couple with the tab region of the busbar by at least two connection points, a first connection point to be disposed on a first side of a longitudinal centerline of the nut plate and a second connection point to be disposed on a second side of the longitudinal centerline of the nut plate, the first connection point and the second connection point disposed a distance away from the longitudinal centerline.

14. The battery module assembly of claim 9, comprising:
the nut plate coupled with the tab region of the busbar by at least one connection point, the at least one connection point to include an irreversible connection, the irreversible connection configured to prevent a misalignment between the one or more openings in the nut plate and the one or more openings of the busbar.

15. The battery module assembly of claim 9, comprising:
the nut plate to irreversibly couple with the tab region of the busbar by at least two connection points, the at least two connection points to be disposed on a first side of the nut plate.

16. The battery module assembly of claim 9, comprising:
the nut plate irreversibly coupled with the tab region of the busbar by at least two connection points;
a first connection point disposed on a side of a first centerline and a second connection point disposed on the side of the first centerline, the first and second connection points disposed a first distance away from the first centerline; and
the first connection point disposed on a first side of a second centerline and the second connection point disposed on a second side of the second centerline, the first and second connection points disposed a second distance away from the second centerline.

17. The battery module assembly of claim 9, comprising:
a portion of a perimeter of the tab region of the busbar to align with a portion of a perimeter of the nut plate.

18. A method, comprising:
aligning one or more openings of a nut plate with one or more openings of a busbar, the one or more openings of the busbar disposed on a tab region of the busbar; and
coupling the nut plate with the tab region of the busbar, at least a portion of a face of the nut plate configured to be flush with a face of the tab region of the busbar.

19. The method of claim 18, comprising:
coupling the nut plate with the tab region of the busbar by at least one connection point, the at least one connection point to include a rivet, the nut plate having a planar shape and the face of the nut plate to be flush with the face of the tab region of the busbar.

20. The method of claim 18, comprising:
coupling the nut plate with the tab region of the busbar by at least one connection point, the at least one connection point to include an irreversible connection, the irreversible connection configured to prevent a misalignment between the one or more openings in the nut plate and the one or more openings of the busbar.
